(19) United States
(12) Patent Application Publication
(10) Pub. No.: US 2015/0158998 A1
(43) Pub. Date: Jun. 11, 2015

(54) GYPSUM COMPOSITE MODIFIERS

(71) Applicants: Flint Hills Resources, LP, Wichita, KS (US); Georgia-Pacific Gypsum LLC, Atlanta, GA (US)

(72) Inventors: Pierre Donaldson, Longview, TX (US); Bill Bodiford, White Oak, TX (US); Michael S. Kerns, Wichita, KS (US); Mianxue Wu, Suwanee, GA (US); Jeffrey T. Fields, Suwanee, GA (US)

(73) Assignee: FLINT HILLS RESOURCES, LP, Wichita, KS (US)

(21) Appl. No.: 14/562,397

(22) Filed: Dec. 5, 2014

Related U.S. Application Data
(60) Provisional application No. 61/913,095, filed on Dec. 6, 2013.

(51) Int. Cl. C08K 7/08

(52) U.S. Cl. CPC C08K 7/08

(57) ABSTRACT

Methods for making composite products and methods for their use and manufacture are provided. In at least one specific embodiment, alpha-derived anhydrite calcium sulfate whiskers and a plastic can be combined to produce a composite product.

### CROSS-REFERENCE TO RELATED APPLICATION

This application claims priority to U.S. Provisional Patent Application No. 61/913,095, filed on Dec. 6, 2013, which is incorporated by reference herein.

### BACKGROUND

1. Field

Embodiments described generally relate to calcium sulfate-based products and methods for making same. More particularly, such embodiments described relate to calcium sulfate whiskers and composite products and methods for their use and manufacture.

2. Description of the Related Art

Various fillers are known for use as reinforcement, opacification, and/or additives in paint, coatings, papermaking, and plastics. For example, fillers such as fiberglass, carbon black, calcium carbonate, silica, talc, kaolin, and aluminum hydroxide are currently used in these applications. However, fibrous fillers generally provide improved stiffness, strength, and thermal stability properties to composites, as compared to particulate and platelet shaped fillers.

Single crystal fibers, also known as “whiskers,” have been shown to provide improved properties in composites as compared to traditional fibers. For example, whiskers can provide improved surface quality and/or aesthetics for composites because they are typically finer and smoother than fibers. Whiskers can also improve dimensional stability, thermal stability, strength, toughness, and/or higher fluidity (e.g., for improved mold casting). However, whiskers are difficult to economically manufacture due to the slow growth rate of whiskers.

Accordingly, there is a need for improved whiskers and composite products made therewith, as well as improved methods for the use and manufacture of whiskers.

### SUMMARY

Methods for making composite products and methods for their use and manufacture are provided. In at least one specific embodiment, alpha-derived anhydrite calcium sulfate whiskers and a plastic can be combined to produce a composite product.

In at least one specific embodiment, the method for making a composite product can include blending a plurality of alpha-derived anhydrite calcium sulfate whiskers and a plastic to produce a composite product. The composite product can include about 1 wt % to about 50 wt % of the alpha-derived anhydrite calcium sulfate whiskers, based on the combined weight of the alpha-derived calcium sulfate whiskers and the plastic.

In at least one specific embodiment, a composite product can include alpha-derived anhydrite calcium sulfate whiskers and a plastic. The plastic can include polyethylene, polypropylene, polybutylene, polyester, polyethylene terephthalate, polycaprolactam, poly(hexamethylene adipamide), polyurethane, epoxy, nitrile rubber, butyl rubber, silicone rubber, polytetrafluoroethylene, phenolics, asphalt, oxidized asphalt, cut-back asphalt, wax, clay, or any mixture thereof.

### BRIEF DESCRIPTION OF THE DRAWINGS

FIG. 1 is a micrograph showing alpha-derived anhydrite calcium sulfate whiskers prepared in accordance with one embodiment of the methods disclosed herein.

FIG. 2 is a micrograph showing beta-derived anhydrite calcium sulfate whiskers.

FIG. 3 depicts a graph showing the elastic modulus of composite samples prepared in accordance with one embodiment of the methods disclosed herein, as tested according to three measuring methods.

### DETAILED DESCRIPTION

Disclosed herein are calcium sulfate-based whiskers and composite products and methods for their use and manufacturing. In one or more embodiments, the calcium sulfate-based whiskers can have an improved aspect ratio compared to known fibers or whiskers. In one or more embodiments, the calcium sulfate-based whiskers can have a faster growth rate as compared to other known whiskers. As used herein, the term “whiskers” refers to single crystal fibers. Generally, the whiskers can be made from calcium sulfate, which can also be referred to as gypsum or plaster. Calcium sulfate can exist as a hemihydrate (CaSO₄.0.5H₂O), a dihydrate (CaSO₄.2H₂O), or an anhydrite (CaSO₄). Generally, the beta calcium sulfate hemihydrate, which is obtained from the calcination of dihydrate calcium sulfate under an elevated temperature at ambient pressure, can be used to prepare beta-derived anhydrite calcium sulfate whiskers. However, it has been discovered that alpha calcium sulfate hemihydrate provides surprising advantages to whisker processing and properties. Alpha calcium sulfate hemihydrate, which has the same chemical composition as the beta form, has gone through a pressurized calcination process that can produce alpha-derived anhydrite calcium sulfate whiskers. The alpha-derived anhydrite sulfate whiskers can be well-crystallized, prismatic particles or whiskers. The pressurized calcination process can be or include an autoclave process.

It should be understood that while the present disclosure generally relates to composite products that include alpha-derived anhydrite calcium sulfate whiskers, the use of other suitable materials is also envisioned and intended to fall within the scope of this disclosure. For example, other particles, such as magnesium oxysulfate, that have been subjected to a pressurized hydrothermal reaction process can also be used. In another example, other forms of calcium sulfate or other materials, e.g., calcium carbonate, which have been reacted with sulfuric acid may be used.

In one or more embodiments, a method for making alpha-derived anhydrite calcium sulfate whiskers can include combining alpha calcium sulfate hemihydrate and water to form a slurry. The slurry can be autoclaved to form alpha calcium sulfate hemihydrate whiskers in water. As used herein, the terms “autoclaved” and “autoclaving” refer to exposing the slurry of calcium sulfate hemihydrate and water to saturated steam in a pressurized environment. The alpha calcium sulfate hemihydrate whiskers can be dewatered and heated to form alpha-derived anhydrite calcium sulfate whiskers.

In one or more embodiments, the amount of alpha calcium sulfate hemihydrate in the slurry can be from a low of about 1 wt %, about 3 wt %, about 5 wt %, about 7 wt %, about 10 wt %, about 15 wt %, or about 20 wt % to a high of about 25 wt %, about 27 wt %, about 30 wt %, about 35 wt %, or about 40 wt %, based on the combined weight of the alpha calcium sulfate hemihydrate and the water. For example, the alpha calcium sulfate hemihydrate can be combined with the water to produce a slurry that includes about 1 wt % to about 20 wt %, about 2 wt % to about 15 wt %, about 2 wt % to about 10 wt %, about 5 wt % to about 8 wt %, about 1 wt % to about 6 wt %, about 4 wt % to about 7 wt %, about 6 wt % to about 12 wt %, about 5 wt % to about 9 wt %, about 10 wt % to about 18 wt %, about 12 wt % to about 26 wt %, about 22 wt % to about 34 wt %, or about 28 wt % to about 38 wt % of the alpha calcium sulfate hemihydrate, based on the combined weight of the alpha calcium sulfate hemihydrate and the water. Without wishing to be bound by theory, it is believed that the combination of alpha calcium sulfate hemihydrate and water results in dihydrate crystals in the slurry.

In one or more embodiments, the alpha calcium sulfate hemihydrate can have a median particle size from a low of about 1 micron, about 3 microns, about 5 microns, about 10 microns, about 20 microns, or about 30 microns to a high of about 50 microns, about 60 microns, about 70 microns, about 80 microns, about 90 microns, or about 100 microns. For example, the alpha calcium sulfate hemihydrate can have a median particle size of about 1 μm to about 20 μm, about 2 μm to about 5 μm, about 1 μm to about 10 μm, about 10 μm to about 40 μm, about 35 μm to about 75 μm, about 55 μm to about 95 μm, or about 65 μm to about 85 μm. In one or more embodiments, the alpha calcium sulfate hemihydrate can be sized to have a median particle size of about 1 μm to about 30 μm, about 1 μm to about 20 μm, about 1 μm to about 10 μm, or about 1 μm to about 5 μm. For example, the alpha calcium sulfate hemihydrate can be sized by jet milling, pulverization, comminuting, separation, micronization, grinding, other suitable sizing or fining processes known to those in the art, or any combination thereof.

The slurry of the alpha calcium sulfate hemihydrate and water can be autoclaved to produce alpha calcium sulfate hemihydrate whiskers in water. For example, the slurry of alpha calcium sulfate hemihydrate and water can be exposed to saturated steam at a pressure from a low of about 0 psig, about 5 psig, about 10 psig, about 20 psig, or about 30 psig to a high of about 40 psig, about 45 psig, about 50 psig, about 55 psig, or about 60 psig. The saturated steam can be at a temperature from a low of about 100° C., about 105° C., about 110° C., about 115° C., or about 120° C. to a high of about 130° C., about 135° C., about 140° C., about 145° C., or about 150° C. The slurry can be autoclaved for a time period or duration from a low of about 30 minutes, about 45 minutes, about 1 hour, or about 2 hours to a high of about 4 hours, about 5 hours, about 6 hours, or about 8 hours. In one example, autoclaving the slurry can include subjecting the slurry to saturated steam at a pressure of about 5 psig to about 55 psig and a temperature of about 100° C. to about 150° C. for a time period or duration of about 30 minutes to about 8 hours. In another example, autoclaving the slurry can include subjecting the slurry to saturated steam at a pressure of about 0 psig to about 50 psig and a temperature of about 100° C. to about 150° C. for a duration of about 30 minutes to about 8 hours. In another example, autoclaving the slurry can include subjecting the slurry to saturated steam at a pressure of about 1 psig to about 30 psig and a temperature of about 101° C. to about 134° C. for a duration from about 30 minutes to about 8 hours. In another example, autoclaving the slurry can include subjecting the slurry to saturated steam at a pressure of about 30 psig to about 52 psig and a temperature of about 134° C. to about 150° C. for a duration from about 30 minutes to about 8 hours. The autoclave parameters or conditions can be e applied in a small-scale production setting, such as in a lab, and/or in an industrial-scale production setting. Without wishing to be bound by theory, it is believed that the calcium sulfate dihydrate crystals, if present, can dissolve during the autoclave process and reform as hemihydrate whiskers at an elevated pressure, e.g., a pressure of about 1 psig to about 60 psig.

After autoclaving the slurry, the alpha calcium sulfate hemihydrate whiskers can be dewatered, i.e., the whiskers can be separated from water. In one or more embodiments, dewatering the alpha calcium sulfate hemihydrate whiskers can include, but is not limited to, filtering, vacuuming, centrifuging, or any combination thereof. For example, a screen filter can be used to dewater the whiskers. In another example, dewatering the alpha calcium sulfate hemihydrate whiskers can include filtering the alpha calcium sulfate hemihydrate whiskers. In another example, dewatering the alpha calcium sulfate hemihydrate whiskers can include filtering the calcium sulfate hemihydrate whiskers for a time period or duration of about 1 minute to about 10 minutes.

The alpha calcium sulfate hemihydrate whiskers can be heated, or “dead burned,” to produce a stable, insoluble anhydrite form. In one or more embodiments, the alpha calcium sulfate hemihydrate whiskers can be heated to a temperature from a low of about 500° C., about 550° C., about 600° C., or about 650° C. to a high of about 700° C., about 800° C., or about 900° C. for a time period or duration from a low of about 1 hour, about 3 hours, about 5 hours, or about 7 hours to a high of about 10 hours, about 13 hours, about 17 hours, about 20 hours, or about 24 hours to produce the alpha-derived anhydrite calcium sulfate whiskers. For example, the alpha calcium sulfate hemihydrate whiskers can be heated to a temperature of about 600° C. to about 700° C. for a time period or duration of about 1 hour to about 2 hours to produce the alpha-derived anhydrite calcium sulfate whiskers.

In one or more embodiments, the alpha-derived anhydrite calcium sulfate whiskers can have a Mohs hardness of about 3 to about 3.5. In one or more embodiments, the alpha-derived anhydrite calcium sulfate whiskers can be thermally stable up to at least 1450° C. In one or more embodiments, the alpha-derived anhydrite calcium sulfate hemihydrate whiskers can have a mean aspect ratio from a low of about 30, about 35, about 40, about 45, about 50, about 55, about 60, or about 65 to a high of about 80, about 90, about 100, about 110, about 120, about 130, or about 140. For example, the alpha-derived anhydrite calcium sulfate whiskers can have a mean aspect ratio of at least 30. As used herein, the term “aspect ratio” refers to the ratio of the length of a calcium sulfate whisker to the diameter of the calcium sulfate whisker, and the “mean aspect ratio” refers to the ratio of the average whisker length to the average whisker diameter for a plurality of whiskers.

In one or more embodiments, compositions that can include whiskers are also provided. For example, the whiskers, e.g., the alpha-derived anhydrite calcium sulfate whiskers, can be lightweight and have desirable properties for structural reinforcement, thermal insulation, and/or acoustic insulation. For example, the whiskers can provide improved dimensional stability, improved thermal stability, increased strength, increased toughness, and/or greater fluidity (e.g., for improved mold casting). The whiskers can also provide improved surface quality and aesthetics for composite products because they are typically finer and smoother than other fibers.

In one or more embodiments, the alpha calcium sulfate hemihydrate can be derived from any suitable source or combination of sources. In one example, alpha calcium sulfate hemihydrate can be produced from residues recovered from coal fired plants. In another example, alpha calcium sulfate hemihydrate can be produced from gypsum products that are out of specification in the gypsum industry. Other processes that can produce calcium sulfate that can be converted to alpha calcium sulfate hemihydrate can include, but are not limited to, flue-gas desulfurization processes, the production of phosphoric acid from phosphate rock, the production of hydrogen fluoride, the refining of zinc, recycled gypsum such as unused drywall at constructions sites or recycled drywall, or any combination thereof.

In one or more embodiments, the alpha-derived anhydrite calcium sulfate whiskers can be combined with one or more base materials, e.g., plastics, to produce a composite product. For example, a plurality of the alpha-derived anhydrite calcium sulfate whiskers and the one or more base materials can be mixed, blended, or otherwise combined with one another to produce the composite product. In one example, the alpha-derived anhydrite calcium sulfate whiskers and base material can be blended with one another in an extruder.

Any one or more of a number of materials can be used as the base material. For example, the base material can be or include, but is not limited to, paper, paper precursors, films, plastics, resins, facers such as fiberglass mats, any combination thereof, or mixture thereof. Generally, alpha-derived anhydrite calcium sulfate whiskers can be used in any application where traditional fillers, opacification agents, or reinforcing additives, such as but not limited to fiberglass, carbon black, calcium carbonate, silica, talc, kaolin, or aluminum hydroxide, have been and/or are currently used. For example, the alpha-derived anhydrite calcium sulfate whiskers can be used in paints and other coatings. In one or more embodiments, the alpha-derived anhydrite calcium sulfate whiskers can be combined with one or more paper materials, one or more plastics, including elastomers, thermoplastics, thermosets, and/or one or more resins, including thermosetting resins to produce composite product.

As used herein, the term “plastic” refers to a wide variety of materials that include both natural materials and synthetic materials and both polymeric materials and non-polymeric materials that are capable of being molded with or without the application of heat. Suitable plastics can include, but are not limited to, one or more elastomeric materials, one or more thermoplastic materials, one or more thermosetting materials, one or more waxes, one or more clays, one or more asphalts, one or more oxidized asphalts, one or more cut-back asphalts, one or more asphalt paints, one or more proteins, one or more polymers, or any mixture thereof. In at least one example, the plastic can also be or include materials generally referred to as resins. Suitable resins can include thermoplastic resins, thermosetting resins, or mixtures thereof. Illustrative resins can include, but are not limited to, polyethylene terephthalate (PET), polyester resins, polyurethanes, phenol-formaldehyde resins (e.g., phenol-formaldehyde novolac resins, phenol-formaldehyde resole resins, or any mixture thereof), urea-formaldehyde resins, melamine-formaldehyde resins, resorcinol-formaldehyde resins, epoxy resins, polyimides, cyanate esters, diallyl-phthalate (DAP) resins, or any mixture thereof. Other suitable plastics include, but are not limited to, fluorocarbon resins, nylon, phenolics, polyimides, silicones, cellulosics, polyethylene, acrylic polymers, polystyrene, polyurethane, acrylonitrile butadiene styrene (ABS), polyphenylene oxide styrene (PPO/styrene), polybutylene terephthalate, casein, zein, or any mixture thereof. In certain embodiments, the plastic can be or include polyethylene, polypropylene, polybutylene, polyester, polyethylene terephthalate (PET), polycaprolactam (nylon 6), poly(hexamethylene adipamide) (nylon 6-6), polyurethane, epoxy, nitrile rubber, butyl rubber, silicone rubber, polytetrafluoroethylene (PTFE), phenolics, or any mixture thereof.

In other embodiments, the plastic can be or include one or more waxes, one or more clays, one or more asphalts, one or more oxidized asphalts, one or more cut-back asphalts, one or more asphalt paints, one or more proteins, or any mixture thereof. Suitable waxes can include natural waxes and/or synthetic waxes. Illustrative natural waxes can include, but are not limited to, animal waxes, vegetable waxes, mineral waxes, or any mixture thereof. Suitable animal waxes can include, but are not limited to, beeswax, lanolin, shellac wax, Chinese insect wax, or any mixture thereof. Illustrative vegetable waxes can include, but are not limited to, carnauba wax, candelilla wax, bay-berry wax, sugar cane wax, or any mixture thereof. Illustrative mineral waxes can include, but are not limited to, fossil or earth waxes such as ozocerite, ceresin, and/or montan, petroleum waxes such as paraffin wax, microcrystalline wax, slack wax, or any mixture thereof. Illustrative synthetic waxes can include, but are not limited to, ethylenic polymers and polyol ether-esters, chlorinated naphthalenes such as halowax, hydrocarbon type waxes such as waxes made via Fischer-Tropsch synthesis, or any mixture thereof. Illustrative clays can include one or more hydrated aluminum silicates such as kaolinite, montmorillonite, atapulgite, illite, bentonite, halloysite, or any mixture thereof. Illustrative proteins can include, but are not limited to, casein, zein, or a mixture thereof.

The phenolic can be or include one or more phenol-formaldehyde resins. For example, one or more phenol-formaldehyde novolac resin, one or more phenol-formaldehyde resole resins, or any mixture thereof. In one or more embodiments, the phenol component can be replaced partially or completely with other phenolic compounds. Thus, the term “phenol” includes phenol and phenol derivatives, e.g., substituted phenols. Substituted phenols can include, but are not limited to, alkyl substituted phenols, aryl substituted phenols, cycloalkyl substituted phenols, alkenyl substituted phenols, alkoxy substituted phenols, aryloxy substituted phenols, and halogen substituted phenols. Illustrative phenol compounds that can be used to produce suitable phenolics can include, but are not limited to, bis-phenol A, bis-phenol F, o-cresol, m-cresol, p-cresol, 3,5-5 xylenol, 3,4-xylenol, 3,4,5-trimethylphenol, 3-ethyl phenol, 3,5-diethyl phenol, p-butyl phenol, 3,5-dibutyl phenol, p-amyl phenol, p-cyclohexyl phenol, p-octyl phenol, 3,5 dicyclohexyl phenol, p-phenyl phenol, p-phenol, 3,5-dimethoxy phenol, 3,4,5 trimethoxy phenol, p-ethoxy phenol, p-butoxy phenol, 3-methyl-4-methoxy phenol, p-phenoxy phenol, naphthol, anthranol and substituted derivatives thereof.

In one embodiment, the plastic can include one or more homopolymers, one or more copolymers, or any mixture thereof. The homopolymers and/or copolymers can be composed of olefins having from 2 to about 40 carbon atoms, preferably olefins having from 2 to about 20 carbon atoms, such as copolymers of an alpha-olefin and another olefin or alpha-olefin (ethylene can be defined to be an alpha-olefin). Accordingly, the term “copolymer” includes polymers composed of two or more monomers. The comonomer can be linear or branched or can include two unsaturated carbon-carbon bonds (dienes). Examples of suitable comonomers can include, but are not limited to, ethylene, propylene, 1-butene; 3-methyl-1-butene; 3,3-dimethyl-1-butene; 1-pentene; 1-pentene with one or more methyl, ethyl, or propyl substituents; 1-hexene; 1-hexene with one or more methyl, ethyl, or propyl substituents; 1-heptene; 1-heptene with one or more methyl, ethyl, or propyl substituents; 1-octene; 1-octene with one or more methyl, ethyl, or propyl substituents; 1-nonene; 1-nonene with one or more methyl, ethyl, or propyl substituents; ethyl, methyl, or dimethyl-substituted 1-decene; 1-dodecene; styrene; or any combination or mixture thereof. Particularly preferred comonomers include ethylene, propylene, 1-butene, 1-hexene, and/or 1-octene.

In one or more embodiments, the polymers can be or include homopolyethylene, homopolypropylene, propylene copolymerized with ethylene and/or butene, ethylene copolymerized with one or more of propylene, butene, and hexene, and optional dienes. Examples include thermoplastic polymers such as ultra low density polyethylene, very low density polyethylene, linear low density polyethylene, low density polyethylene, medium density polyethylene, high density polyethylene, polypropylene, isotactic polypropylene, highly isotactic polypropylene, syndiotactic polypropylene, random copolymers of propylene and ethylene and/or butene and/or hexene, elastomers such as ethylene propylene rubber, ethylene propylene diene monomer rubber, neoprene, and blends of thermoplastic polymers and elastomers, such as for example thermoplastic elastomers and rubber toughened plastics. In another embodiment, the plastic can be or include an ethylene homopolymer, an ethylene copolymer, a propylene homopolymer, a propylene copolymer, or a mixture or blend thereof.

Thermoplastic copolymers that include about 10 wt % to about 20 wt % ethylene and/or other comonomer(s) are generally referred to as impact copolymers “ICPs” and thermoplastic copolymers that include greater than 20 wt % to about 40 wt % ethylene and/or other comonomer(s) are generally referred to as polyolefin elastomers or “TPOs.” Thermoplastic copolymers that include less than 10 wt % ethylene and/or other comonomer(s) are generally referred to as random copolymers. In one or more embodiments, the plastic can be or include a thermoplastic copolymer that can include a blend of a polypropylene homopolymer and a copolymer that can include propylene and one or more comonomers selected from the group consisting of: ethylene and C₄ to C₂₀ olefins. For example, the plastic can be or include a thermoplastic copolymer that can include a blend of a polypropylene homopolymer and a copolymer that can include propylene and one or more comonomers selected from the group consisting of: ethylene and C₄ to C₂₀ olefins, where the thermoplastic copolymer includes about 1 wt % to about 9.9 wt % of the comonomer. In another example, the plastic can be or include a thermoplastic copolymer that can include a blend of a polypropylene homopolymer and a copolymer that can include propylene and one or more comonomers selected from the group consisting of: ethylene and C₄ to C₂₀ olefins, where the thermoplastic copolymer includes about 1 wt % up to 9.9 wt % of the comonomer. In another example, the plastic can be or include a thermoplastic copolymer that can include a blend of a polypropylene homopolymer and a copolymer that can include propylene and one or more comonomers selected from the group consisting of: ethylene and C₄ to C₂₀ olefins, where the thermoplastic copolymer includes about 10 wt % to about 20 wt % of the comonomer. In another example, the plastic can be or include a thermoplastic copolymer that can include a blend of a polypropylene homopolymer and a copolymer that can include propylene and one or more comonomers selected from the group consisting of: ethylene and C₄ to C₂₀ olefins, where the thermoplastic copolymer includes greater than 10 wt % up to 20 wt % of the comonomer. In another example, the plastic can be or include a thermoplastic copolymer that can include a blend of a polypropylene homopolymer and a copolymer that can include propylene and one or more comonomers selected from the group consisting of: ethylene and C₄ to C₂₀ olefins, where the thermoplastic copolymer includes about 20 wt % to about 40 wt % of the comonomer. In another example, the plastic can be or include a thermoplastic copolymer that can include a blend of a polypropylene homopolymer and a copolymer that can include propylene and one or more comonomers selected from the group consisting of: ethylene and C₄ to C₂₀ olefins, where the thermoplastic copolymer includes greater than 20 wt % to about 40 wt % of the comonomer.

In one or more embodiments, the amount of the alpha-derived anhydrite calcium sulfate whiskers in the composite product can be from a low of about 1 wt %, about 3 wt %, about 5 wt %, about 7 wt % or about 10 wt % to a high of about 15 wt %, about 20 wt %, about 25 wt %, about 30 wt %, about 35 wt %, about 40 wt %, about 45 wt %, or about 50 wt %, based on the combined weight of the alpha-derived calcium sulfate whiskers and the base material, e.g., plastic. For example, the composite product can include about 1 wt % to about 50 wt %, about 2 wt % to about 40 wt %, about 5 wt % to about 15 wt %, about 12 wt % to about 33 wt %, about 1 wt % to about 8 wt %, about 4 wt % to about 12 wt %, or about 3 wt % to about 10 wt % of the alpha-derived anhydrite calcium sulfate whiskers, based on the combined weight of the alpha-derived calcium sulfate whiskers and the base material, e.g., plastic.

In one example, the composite product can include polypropylene as the plastic and about 2 wt % to about 20 wt % alpha-derived anhydrite calcium sulfate whiskers, based on the combined weight of the polypropylene and the alpha-derived anhydrite calcium sulfate whiskers. In another example, a composite product can include polypropylene as the plastic and about 4 wt % to about 10 wt % alpha-derived anhydrite calcium sulfate whiskers, based on the combined weight of the polypropylene and the alpha-derived anhydrite calcium sulfate whiskers. In one example, the composite product can include polyethylene as the plastic and about 2 wt % to about 20 wt % alpha-derived anhydrite calcium sulfate whiskers, based on the combined weight of the polyethylene and the alpha-derived anhydrite calcium sulfate whiskers. In another example, a composite product can include polyethylene as the plastic and about 4 wt % to about 10 wt % alpha-derived anhydrite calcium sulfate whiskers, based on the combined weight of the polyethylene and the alpha-derived anhydrite calcium sulfate whiskers.

In one or more embodiments, the composite product can have an elastic modulus of at least 1,000 MPa, such as the composite product of the polypropylene and the alpha-derived anhydrite calcium sulfate whiskers. In one or more embodiments, the composite product can have an elastic modulus of at least 1,000 MPa, at least 1,050 MPa, at least 1,100 MPA, at least 1,150 MPa, at least 1,200 MPa, or at least 1,240 MPa to about 1,250 MPa, about 1,275 MPa, about 1,300 MPa, or about 1,350 MPa, as measured according to the Flexural Chord method. In one or more embodiments, the composite product can have an elastic modulus of at least 1,000 MPA, at least 1,050 MPa, at least 1,100 MPA, at least 1,150 MPa, at least 1,200 MPa, at least 1,250 MPa, or at least 1,300 MPa to about 1,325 MPa, about 1,350 MPa, about 1,400 MPa, or about 1,450 MPa, as measured according to the Flexural Tangent method. In one or more embodiments, the composite product can have an elastic modulus of at least 1,000 MPa, at least 1,010 MPA, at least 1,025 MPA, or at least 1,030 MPA to about 1,050 MPa, about 1,075 MPa, about 1,100 MPa, about 1,125 MPa, or about 1,150 MPa, as measured according to the Flexural Secant method.

In one or more embodiments, the alpha-derived anhydrite calcium sulfate whiskers can be mixed, blended, or otherwise combined with the base material, e.g., plastic using any desired process or combination of processes. When the base material includes a plastic, the plastic can be in the solid phase, a molten phase, or a mixture of a solid phase and a molten phase. For example, the plastic can be melted in an extruder and the alpha-derived anhydrite calcium sulfate whiskers can be introduced to the molten or melted plastic therein to produce the composite product. In another example, the plastic, in the form of particulates, can be combined with the alpha-derived anhydrite calcium sulfate whiskers within an extruder. The plastic particulates can melt after the alpha-derived anhydrite calcium sulfate whiskers are combined therewith. In another example, the plastic particulates can be partially melted, i.e., both solid and molten plastic can be present, when the alpha-derived anhydrite calcium sulfate whiskers are combined therewith.

In one or more embodiments, a method for making a composite product can include heating a plastic to the molten state, combining the alpha-derived anhydrite calcium sulfate whiskers with the plastic while in the molten state, extruding the molten plastic and alpha-derived anhydrite calcium sulfate whiskers through a die, and cutting the extruded composite into pellets with a blade as the composite exits the die. In one or more embodiments, a method for making a composite product can include heating a plastic to produce a substantially melted plastic and combining alpha-derived anhydrite calcium sulfate whiskers with the melted plastic to produce a blended mixture. The blended mixture can be cooled to produce a composite product.

One potential drawback of magnesium sulfate whiskers is that at a temperature of about 240° C. to about 270° C. the magnesium sulfate whiskers will degrade and release water. In one or more embodiments, composite products that include plastics having a melting point of greater than 240° C., greater than 245° C., greater than 250° C., greater than 255° C., greater than 260° C., greater than 265° C., greater than 270° C., greater than 275° C., greater than 280° C., greater than 285° C., or greater than 290° C. can be combined with the alpha-derived anhydrite calcium sulfate whiskers. For example, composite products that include plastics having a melting point of greater than 240° C. to about 300° C., greater than 250° C. to about 320° C., greater than 240° C. to about 290° C., greater than 260° C. to about 340° C., greater than 270° C. to about 310° C., or greater than 240° C. to about 340° C. or more can be combined with the alpha-derived anhydrite calcium sulfate whiskers. As such, alpha-derived anhydrite calcium sulfate whiskers can be combined with plastics having a greater melting point than plastics that magnesium sulfate whiskers can be combined with to produce composite products.

The mechanical properties of the composite products can be improved by treating the surface of the alpha-derived anhydrite calcium sulfate whiskers before the whiskers are combined with the base material, e.g., plastic. In one or more embodiments, the alpha-derived anhydrite calcium sulfate whiskers can be treated with one or more treatment materials, e.g., at least partially coated, to produce treated alpha-derived anhydrite calcium sulfate whiskers. Illustrative treatment materials can include, but are not limited to, one or more silicon containing compounds, e.g., silane, one or more waxes, one or more stearates, steric acid, or any mixture thereof. The treatment material can be in the form of a liquid, a gas, a solid, e.g., powder or granular form, or any combination thereof. Treating the alpha-derived anhydrite calcium sulfate whiskers can also include functionalization of the surface of the whiskers. In one example, one or more silane coupling agents, or other additives capable of coupling or compatibilizing inorganic materials to organic resins, such as 3-methacryloxypropyltrimethoxysilane, can be used as the treatment material. In another example, calcium stearate can be used as the treatment material.

In one or more embodiments, the one or more treatment materials, if present, can be combined with the alpha-derived anhydrite calcium sulfate whiskers in an amount from a low of about 0.1 wt %, about 0.5 wt %, about 1 wt %, or about 1.5 wt % to a high of about 2 wt %, about 3 wt %, about 4 wt %, about 5 wt %, about 7 wt %, or about 10 wt %, based on the weight of the alpha-derived anhydrite calcium sulfate whiskers. For example, the one or more treatment materials, if present, can be combined with the alpha-derived anhydrite calcium sulfate whiskers in an amount of about 0.7 wt % to about 3.7 wt %, about 1.5 wt % to about 2.5 wt %, about 1 wt % to about 2 wt %, about 2 wt % to about 3 wt %, about 3.5 wt % to about 5 wt %, or about 0.5 wt % to about 4.5 wt %, based on the weight of the alpha-derived anhydrite calcium sulfate whiskers.

Unexpectedly, it has been found that composite products made with the treated alpha-derived anhydrite calcium sulfate whiskers In one or more embodiments, the composite product that includes treated alpha-derived anhydrite calcium sulfate whiskers can have a yellowness index (plaques) of less than 20, less than 19, less than 18, less than 17, less than 16.5, less than 16, less than 15.5, less than 15, less than 14.5, less than 14, less than 13.5, or less than 13, as measured according to ASTM D6290 E313. In at least one specific embodiment, a composite product that includes about 200 ppm of the treatment material, about 10 wt % of the alpha-derived anhydrite calcium sulfate whiskers, and about 90 wt % polypropylene can have a yellowness index that is less than a yellowness index of a comparative composite product that is the same except for no treatment material was used in the preparation thereof. In at least one other embodiment, a composite product that includes about 200 ppm of the treatment material, about 10 wt % of the alpha-derived anhydrite calcium sulfate whiskers, and about 90 wt % polypropylene and has undergone two extrusion heat histories can have a yellowness index that is less than a yellowness index of a comparative composite product that is the same except for no treatment material was used in the preparation thereof and has only been subjected to one extrusion heat history.

In one or more embodiments, one or more additives can be combined with alpha-derived anhydrite calcium sulfate whiskers and the base material, e.g., plastic. Illustrative additives that can be present in the composite product that includes the alpha-derived anhydrite calcium sulfate whiskers and the base material can include, but are not limited to, fragrances, tackifiers, waxes, functionalized polymers such as acid modified polyolefins and/or anhydride modified polyolefins, antioxidants (e.g., hindered phenolics such as IRGANOX® 1010 or IRGANOX® 1076 available from Ciba-Geigy), (e.g., IRGAFOS® 168 available from Ciba-Geigy), oils, compatibilizers, adjuvants, adhesion promoters, plasticizers, low molecular weight polymers, blocking agents, antiblocking agents, anti-static agents, release agents, anti-cling additives, colorants, processing aids, UV stabilizers, heat stabilizers, neutralizers, lubricants, surfactants, nucleating agents, flexibilizers, rubbers, optical brighteners, diluents, viscosity modifiers, oxidized polyolefins, or any combination or mixture thereof. Illustrative fragrances can include, but are not limited to, mint extract, lemon extract, vanilla extract, or any mixture thereof. Illustrative colorants can include, but are not limited to, titanium dioxide, calcium carbonate, zinc oxide, talc, kaolin, wollastonite, or any mixture thereof. It should be noted that one or more additives can serve one purpose or more than one purpose. For example, if the blended composition includes titanium dioxide, calcium carbonate, or other colorant that colorant can also serve as an inorganic filler component in the blended composition. The use of these additives and others are well known in the art.

The composite product that includes the whiskers and the base material, e.g., plastic, can be used in a wide variety of applications involving molding or extrusion, including consumer goods, industrial goods, construction materials, packaging materials, and automotive parts. Articles can be made, formed, extruded, or otherwise manufactured with the composite via any useful molding or extrusion process capable of forming and shaping polymers. Suitable processes for manufacturing a given composite product can include, but are not limited to, compression molding, injection molding, co-injection molding, gas-assisted injection molding, thermoforming, blow molding, multi-layer blow molding, injection blow molding, stretch blow molding, extrusion blow molding, transfer molding; cast molding, rotational molding, foam molding, slush molding, transfer molding, wet lay-up or contact molding, cast molding, cold forming matched-die molding, vacuum forming, film blowing, film or sheet casting, sheet extrusion, profile extrusion or co-extrusion, fiber spinning, fiber spunbonding, fiber melt blowing, lamination, calendering, coating, pultrusion, protrusion, draw reduction, foaming, or combinations thereof.

Illustrative composite products can include, but are not limited to, tubing, pipes, packaging such as durable and disposable packaging, household items such as tumblers and plates, household appliances such as washing machines, refrigerators, blenders, air conditioners, etc., indoor and outdoor furniture such as tables, chairs, benches, shelving, etc., sporting equipment such as skis, surfboards, skateboards, skates, boots, sleds, scooters, kayaks, paddles, etc., solid wheels, stadium seating, amusement park rides, personal protective equipment such as safety helmets, shin guards, etc., cookware, utensils, trays, pallets, carts, tanks, tubs, pond liners, storage containers such as crates, pails, jars, bottles, etc., toys, child car seats and booster chairs, medical devices, sportswear, luggage, tool housings such as those for drills, saws, etc., electronics housings such as those for televisions, computers, phones, hand-held devices, media players, stereos, radios, clocks, etc., building construction materials such as flooring, siding, roofing, counter tops, electrical housings and connectors, etc., lighting, gardening equipment such as handles on shovels, wheelbarrows, etc., playground equipment, motor housings, pump housings, battery housings, instrument housings, switches, knobs, buttons, handles, pet supplies, laboratory supplies, personal hygiene devices such as razors, brushes, hairdryers, etc., cleaning supplies such as brooms, dust pans, etc., musical instrument cases, statues, trophies, artwork, costume jewelry, picture frames, eyeglass frames, plant pots, cosmetic packaging, flower pots, appliance covers, plastic trim for use in homes, decorative items, stands such as those for supporting plants, soap closures and dispensers, caps and closures, toys, crates, portable coolers or ice chests, parts meters, water dispersing tools such as sprinklers and sprayers, firearm components, and automotive components.

Considering automotive components in more detail, the composite products that include the whiskers and the base material, e.g., plastic, can include, but are not limited to, bumpers, exterior and/or interior body panels such as door panels; exterior trim pieces, including body side moldings, side cladding and molding, end caps, hoods, deck lids, mirror housings, roof racks, wheel covers, wheel liners, wheel flares, fender liners, hub caps, running boards, step pads, sill plates, air dams, splash shields, mud guards, bed liners, and rocker panels; fuel tanks; interior trim pieces, including steering column covers, consoles, door panels, pillars, supports, knobs, buttons, handles, and safety screens, instrument panels, dash boards, knee bolsters, passenger side airbag covers, headliners, glove boxes, trays, cup holders, compartments, and lids; seat components, including backs, supports, and safety belt securing devices; under-hood components, including battery trays and fan shrouds; electrical housings; cable bearings; and structural components, including door carriers, truck bed separators, load floors, and trunk dividers. One particularly well suited application for the composite products that include the whiskers and base material, e.g., plastic, can include “under the hood” automotive applications that currently contain long or short glass fibers. A solid molten log of material can be extruded that contains the composite that can be laid in a mold cavity and compression molded to form the composite into the desired end configuration. A potentially well suited application for the composite products that include the whiskers and the base material, e.g., plastic, can include headliners for automobiles and other vehicles. The whiskers can be blended with a base material, e.g., polypropylene, and the blend can be mixed in a liquid solution and run through a vented extruder. Sheets can then formed that can be vacuum formed to make headliners for automobiles and other vehicles.

### EXAMPLES

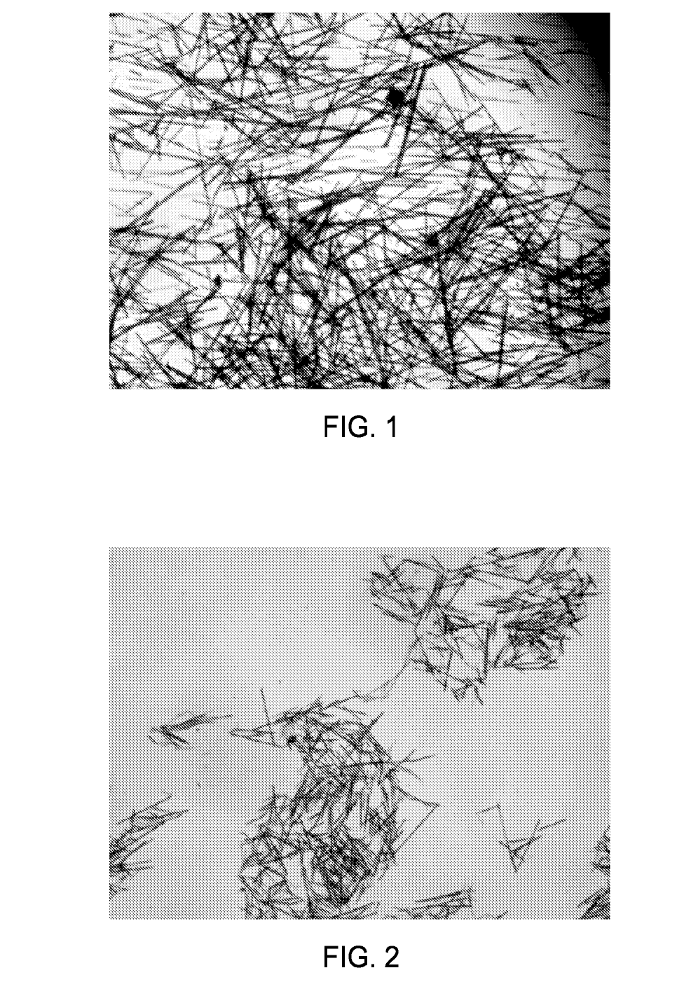

In order to provide a better understanding of the foregoing discussion, the following non-limiting examples are offered. Although the examples may be directed to specific embodiments, they are not to be viewed as limiting the invention in any specific respect. Embodiments of the calcium sulfate whiskers and composites discussed and described herein were manufactured and tested. The results are shown below and in FIGS. 1-3.

### Example 1

Calcium sulfate whiskers were prepared using alpha and beta hemihydrate particles mined from the same location, according to the following method. Calcium sulfate hemihydrate was combined with water to form a slurry containing 5 weight percent calcium sulfate. The slurry was autoclaved at a pressure of 10 psi and a temperature of 115° C. for about 2 hours to form whiskers. The whiskers were dewatered by screen filtering for 5 minutes. The dewatered whiskers were heated at a temperature between about 600° C. and about 700° C. for about 3 hours to form stable, insoluble alpha-derived calcium sulfate anhydrite whiskers.

FIG. 1 is a micrograph (600×400 microns) taken by polarized light microscopy showing the alpha-derived anhydrite calcium sulfate whiskers prepared according to the method discussed above. FIG. 2 is a micrograph (600×400 microns) taken by polarized light microscopy showing the beta-derived anhydrite calcium sulfate whiskers prepared by the same method as the alpha whiskers. These micrographs show the distinct morphology (i.e., length and diameter) of the alpha-derived whiskers versus the beta-derived whiskers. More particularly, in comparing the alpha-derived whiskers in FIG. 1 with the beta-derived whiskers in FIG. 2, the alpha-derived whiskers were much longer than the beta-derived whiskers, and had a greater aspect ratio than the beta-derived whiskers. Furthermore, the micrographs reveal that the growth rate was much faster for the alpha-derived whiskers than the beta-derived whiskers.

Specifically, it has been determined that the alpha calcium sulfate has a crystal growth rate of at least 3-5 times that of beta calcium sulfate. Thus, the autoclave time needed to make whiskers of identical length is much shorter with the alpha calcium sulfate, reducing the necessary processing time. This is significant because the low growth rate of beta calcium sulfate whiskers led to high economical costs for manufacturing, making the practical applications of calcium sulfate whiskers cost-prohibitive. Without wishing to be bound by theory, it is believe that due to its “pre-autoclaved” nature, alpha calcium sulfate is able to more quickly grow into elongated whiskers under the autoclave environment.

### Example 2

Alpha-derived and beta-derived calcium sulfate whiskers were prepared in accordance with the method of Example 1. The whiskers were combined with polypropylene to form composites and the stiffness/flexural modulus of each composite was measured according to the Chord method and compared against the stiffness/flexural modulus of the polypropylene alone. The results are shown below in Table 1.

The whiskers were either premixed or side fed with the polypropylene. The term “premixed” in Table 1 refers to the whiskers being combined with extruded polypropylene pellets prior to melting to form a composite. The phrase “side fed” in Table 1 refers to the whiskers being fed into the extruder when the polypropylene is already molten.

TABLE 1
Stiffness/Flexural Modulus of Whisker-
Reinforced Polypropylene Composites

| | Flexural Modulus of | Flexural | |
|---|---|---|---|
| | Whisker-Reinforced | Modulus of | Increased |
| | Polypropylene | Polypropylene | Stiffness |
| Sample | (MPa) | (MPa) | (%) |
| Beta-derived | 813 | 863 | −5.8 |
| whiskers: 10 wt. % | | | |
| premixed | | | |
| Beta-derived | 1,106 | 1,085 | 1.9 |
| whiskers: 10 wt. % | | | |
| premixed | | | |
| Alpha-derived | 1,060 | 754 | 40.6 |
| whiskers: 10.1 wt. % | | | |
| premixed | | | |
| Alpha-derived | 1,240 | 754 | 64.5 |
| whiskers: 4.39 wt. % | | | |
| side fed | | | |
| Alpha-derived | 1,630 | 834 | 95.4 |
| whiskers: 9.25 wt. % | | | |
| side fed | | | |
| Alpha-derived | 1,886 | 849 | 122.1 |
| whiskers: 9.49 wt. % | | | |
| side fed | | | |

These results show that polypropylene composites with alpha-derived anhydrite calcium sulfate whisker reinforcement display much better mechanical properties than composites with comparable beta whisker reinforcement. Without wishing to be bound by theory, it is believed that the premixed process causes the whiskers to be ground up by the unmelted polypropylene pellets, which can result in a lessened reinforcing effect of the whiskers. However, the premixed alpha whiskers performed surprisingly well, showing a 40% increase in stiffness, as compared to the premixed beta whiskers, which showed negligible stiffness increases.

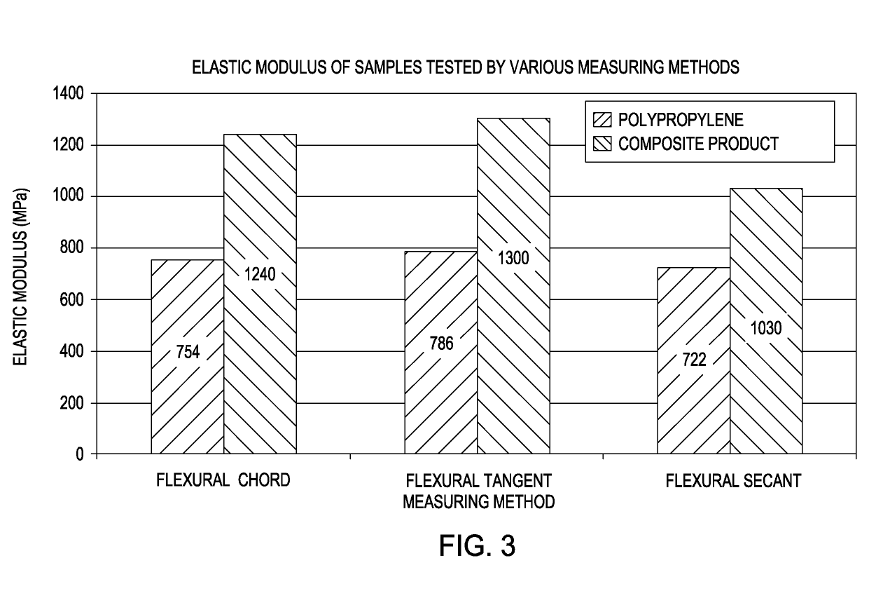

FIG. 3 shows the elastic modulus of a base polypropylene versus a composite product that included the base polypropylene and about 4.39 wt % alpha-derived anhydrite calcium sulfate whiskers, measured according to the Flexural Chord, Flexural Tangent, and Flexural Secant methods. As shown, the stiffness of the polypropylene composite increased significantly (up to 65%) with the addition of the alpha-derived calcium sulfate whiskers.

### Example 3

The commercially obtained alpha calcium sulfate hemihydrate particles used in the foregoing examples had a median particle size of 15.4 μm and a maximum particle size of 120 μm. Micronized alpha calcium sulfate hemihydrate particles were also prepared and tested. Specifically, commercially obtained alpha calcium sulfate hemihydrate particles were ground in a jet mill to a median particle size of about 3.06 μm and a maximum particle size of about 12 μm. Thus, the micronized particles were smaller and more uniform in size than the commercially obtained calcium sulfate hemihydrate particles, as shown in Table 2.

TABLE 2
Micronized Alpha Calcium Sulfate
Particle Dimension Distributions

| | D₁₀ Particle | D₅₀ Particle | D₉₀ Particle | D₁₀₀ Particle |
|---|---|---|---|---|
| | Size: 10^{th} | Size: 50^{th} | Size: 90^{th} | Size: 100^{th} |
| | Percentile | Percentile | Percentile | Percentile |
| Time | (μm) | (μm) | (μm) | (μm) |
| Before | 2.55 | 15.72 | 52.83 | 120.22 |
| Micronizing | | | | |
| After | 1.13 | 3.06 | 6.42 | 12.00 |
| Micronizing | | | | |

The particles were jet milled on a fluid energy mill employing compressed air to produce the smaller particles. High-speed rotation within the mill subjected the calcium sulfate particles to particle-on-particle impact. As shown in Table 2, the micronized particles displayed a maximum size that was 10 times less than the commercially obtained particles. Also, the micronized particles had a maximum particle size that was less than 4 times the average particle size.

Comparative samples of alpha-derived calcium sulfate whiskers were prepared by the method of Example 1 with commercially obtained alpha calcium sulfate hemihydrate particles, but at a lower concentration of 2.5 wt % in the slurry. Commercially available magnesium oxysulfate whiskers were also obtained for comparative purposes. Comparative samples of alpha-derived calcium sulfate whiskers were also prepared by the method of Example 1 with commercially obtained alpha calcium sulfate hemihydrate particles. Alpha-derived calcium sulfate whiskers were prepared by the method of Example 1 with the micronized alpha calcium sulfate hemihydrate particles. Alpha-derived calcium sulfate whiskers were also prepared by the method of Example 1 with a mixture of the commercially obtained alpha calcium sulfate hemihydrate particles and the micronized alpha calcium sulfate hemihydrate particles, but at a lower concentration of 2.5 wt % in the slurry. The average length and diameter was measured by scanning electron microscopy for the resulting whiskers, and the aspect ratio was calculated. The results are shown in Table 3.

TABLE 3
Length, Diameter, and Aspect Ratio for Various Whisker Samples

| | Average Length | Average Diameter | Aspect Ratio |
|---|---|---|---|
| Sample | (μm) | (μm) | (L/D) |
| Low Concentration | 71.1 | 1.27 | 56.1 |
| Whiskers | | | |
| Magnesium | 22.2 | 0.36 | 62.3 |
| oxysulfate | | | |
| Whiskers | | | |
| Standard Alpha | 64.4 | 1.36 | 47.5 |
| Whiskers | | | |
| (Example 1) | | | |
| Micronized Alpha | 48.8 | 0.75 | 64.9 |
| Whiskers | | | |
| Micronized Alpha | 52.6 | 0.48 | 109 |
| and Low | | | |
| Concentration | | | |
| Whiskers | | | |

As shown in Table 3, the micronized alpha-derived anhydrite calcium sulfate whiskers surprisingly had a significantly higher aspect ratio than the standard alpha-derived anhydrite calcium sulfate whiskers (almost 40% greater), with a slightly shorter length and a smaller diameter. The low concentration commercial particle-derived whiskers also showed a slightly higher aspect ratio than the standard whiskers, while the low concentration micronized particle-derived and commercial particle-derived whiskers showed a significantly higher aspect ratio than all other samples. The magnesium sulfate whiskers are much shorter than the calcium sulfate whiskers, and have an even smaller diameter. Generally, an aspect ratio above 30 is desirable for reinforcement applications, with higher aspect ratios providing better structural reinforcement. Also, finer whiskers tend not to settle in the dispersion after autoclaving, such that they can avoid the crowdedness that often results in a localized and excessively high concentration of crystals and thus short whiskers. However, micronizing the calcium sulfate adds processing time and cost to the whisker manufacturing process. Overall, these examples show that alpha-derived anhydrite calcium sulfate whiskers can be manufactured to have application-specific dimensions.

### Example 4

A first composite was made by blending alpha-derived calcium sulfate whiskers with polypropylene in an extruder. A second composite was made by blending alpha-derived calcium sulfate whiskers that had been treated with calcium stearate with polypropylene in an extruder. Alpha-derived calcium sulfate whiskers and calcium stearate in an amount of about 2 wt %, based on the weight of the whiskers, were added to a drum tumbler and mixed for about 10 minutes. The amount of the alpha-derived calcium sulfate whiskers treated with the calcium stearate that could be mixed with the polypropylene increased by 100% relative to the untreated alpha-derived calcium sulfate whiskers used to make the first composite. Additionally, while the untreated alpha-derived calcium sulfate whiskers tended to agglomerate, no agglomeration of the alpha-derived calcium sulfate whiskers treated with the calcium stearate was observed during blending of the whiskers with the polypropylene to make the second composite.

### Example 5

In making the second composite of Example 4, an unexpected outcome was observed. While the amount of calcium stearate was only about 200 ppm in the second composite product, based on the combined weight of the polypropylene, the alpha-derived calcium sulfate whiskers, and the calcium stearate, an improvement in the color of plaques made from the second composite, which contained 10 wt % whiskers was observed. Even when the second product was subjected to an extra extrusion heat history, the second product still had a lower yellowness index than the first composite had after only one heat history. The yellowness index measured on the first composite with one heat history was 16.5. The yellowness index of the second composite that had two heat histories was only 15.5. The yellowness index was measured according to ASTM D6290 E313.

### Example 6

A first polypropylene sample was prepared that included about 8 wt % magnesium sulfate whiskers and about 12 wt % ethylene butene elastomer, and had been nucleated was prepared. A second polypropylene sample and a third polypropylene sample were also prepared that each included about 8 wt % alpha-derived calcium sulfate whiskers and about 12 wt % ethylene butene elastomer and had been nucleated. Aggressive paint adhesion and tabor scuff abrasion testing was performed on all three samples using 4 inch by 6 inch plaques that were injection molded. The paint adhesion results for all three samples were excellent. The average tabor scuff for the second and third polypropylene samples was 0% scuff loss and 1.35% scuff loss, respectively. In contrast, the average tabor scuff for the first polypropylene sample was 9.6% scuff loss.

Even though the first polypropylene sample showed excellent paint adhesion it is known it will not perform well under some elevated temperatures using water or a saltwater spray and a chlorinated polyolefin as an adhesion promoter. The magnesium sulfate whiskers will react with the chlorinated polyolefin and water and will combine and create a salt that will show up as poor adhesion and blisters on the painted part. Without wishing to be bound by theory, it is believed that polypropylene (and other base materials) blended with the alpha-derived calcium sulfate whiskers (e.g., the second and third samples) instead of the magnesium sulfate whiskers will not suffer these detrimental defects because the alpha-derived calcium sulfate whiskers can be made to have no water bound thereto.

Embodiments of the present disclosure further relate to any one or more of the following paragraphs:

1. A method for making a composite product comprising combining alpha-derived anhydrite calcium sulfate whiskers and a plastic to produce a composite product.

2. A method for making a composite product, comprising: blending a plurality of alpha-derived anhydrite calcium sulfate whiskers and a plastic to produce a composite product, wherein the composite product comprises about 1 wt % to about 50 wt % of the alpha-derived anhydrite calcium sulfate whiskers, based on the combined weight of the alpha-derived calcium sulfate whiskers and the plastic.

3. A composite product comprising alpha-derived anhydrite calcium sulfate whiskers and a plastic.

4. A method for making a composite product, comprising: autoclaving a slurry comprising alpha calcium sulfate hemihydrate particles and water to produce alpha calcium sulfate hemihydrate whiskers in water; dewatering the alpha calcium sulfate hemihydrate whiskers; heating the alpha calcium sulfate hemihydrate whiskers to produce alpha-derived anhydrite calcium sulfate whiskers; and combining at least a portion of the alpha-derived anhydrite calcium sulfate whiskers with a plastic to produce a composite product.

5. A method for making alpha-derived anhydrite calcium sulfate whiskers, comprising: autoclaving a slurry comprising alpha calcium sulfate hemihydrate and water to produce alpha calcium sulfate hemihydrate whiskers in water; dewatering the alpha calcium sulfate hemihydrate whiskers; and heating the alpha calcium sulfate hemihydrate whiskers to produce alpha-derived anhydrite calcium sulfate whiskers.

6. The method or composite product according to any one of paragraphs 1 to 4, wherein the plastic comprises a homopolymer, a copolymer, or a mixture thereof.

7. method or composite product according to any one of paragraphs 1 to 4, wherein the plastic comprises a polyethylene homopolymer, a polypropylene homopolymer, a polyethylene copolymer, a polypropylene copolymer, or any mixture thereof.

8. The method or composite product according to any one of paragraphs 1 to 4, wherein the plastic comprises a thermoplastic copolymer, and wherein the thermoplastic copolymer comprises a blend of a polypropylene homopolymer and a copolymer comprising propylene and one or more comonomers selected from the group consisting of: ethylene and C₄ to C₂₀ olefins.

9. The method or composite product according to paragraph 8, wherein the thermoplastic copolymer comprises about 1 wt % to about 9.9 wt % of the comonomer.

10. The method or composite product according to paragraph 8, wherein the thermoplastic copolymer comprises about 1 wt % to about 9.9 wt % ethylene as of the comonomer.

11. The method or composite product according to paragraph 8, wherein the thermoplastic copolymer comprises about 10 wt % to about 20 wt % of the comonomer.

12. The method or composite product according to paragraph 8, wherein the thermoplastic copolymer comprises about 10 wt % to about 20 wt % ethylene as the comonomer.

13. The method or composite product according to paragraph 8, wherein the thermoplastic copolymer comprises greater than 20 wt % to about 40 wt % of the comonomer.

14. The method or composite product according to paragraph 8, wherein the thermoplastic copolymer comprises greater than 20 wt % to about 40 wt % ethylene as the comonomer.

15. The method or composite product according to any one of paragraphs 1 to 4, wherein the plastic comprises polyethylene, polypropylene, polybutylene, polyester, polyethylene terephthalate, polycaprolactam, poly(hexamethylene adipamide), polyurethane, epoxy, nitrile rubber, butyl rubber, silicone rubber, polytetrafluoroethylene, phenolics, or any mixture thereof.

16. The method or composite product according to any one of paragraphs 1 to 4 or 6 to 15, wherein the plastic comprises asphalt, oxidized asphalt, cut-back asphalt, wax, clay, or any mixture thereof.

17. The method or composite product according to any one of paragraphs 1 to 16, wherein the alpha-derived anhydrite calcium sulfate whiskers have a mean aspect ratio of about 30 to about 140.

18. The method or composite product according to any one of paragraphs 1 to 17, wherein the alpha-derived anhydrite calcium sulfate whiskers have a mean diameter of about 0.3 μm to about 1.5 μm.

19. The method or composite product according to any one of paragraphs 1 to 18, wherein the anhydrite calcium sulfate whiskers have a mean length of about 20 μm to about 100 μm.

20. The method or composite product according to any one of paragraphs 1 to 4 or 6 to 19, wherein the anhydrite calcium sulfate whiskers are combined with the plastic when the plastic is in a molten state.

21. The method or composite product according to any one of paragraphs 1 to 4 or 6 to 20, wherein the plastic comprises polypropylene.

22. The method or composite product according to any one of paragraphs 1, 3, 4 or 6 to 21, wherein the composite product comprises about 1 wt % to about 50 wt % of the alpha-derived anhydrite calcium sulfate whiskers, based on the combined weight of the alpha-derived anhydrite calcium sulfate whiskers and the plastic.

23. The method or composite product according to any one of paragraphs 1 to 4 or 6 to 21, wherein the composite product comprises about 2 wt % to about 20 wt % of the alpha-derived anhydrite calcium sulfate whiskers, based on the combined weight of the alpha-derived anhydrite calcium sulfate whiskers and the plastic.

24. The method or composite product according to any one of paragraphs 1 to 4 or 6 to 21, wherein the composite product comprises about 1 wt % to about 10 wt % of the alpha-derived anhydrite calcium sulfate whiskers, based on the combined weight of the alpha-derived anhydrite calcium sulfate whiskers and the plastic.

25. The method or composite product according to any one of paragraphs 1 to 4 or 6 to 21, wherein the composite product comprises about 5 wt % to about 15 wt % of the alpha-derived anhydrite calcium sulfate whiskers, based on the combined weight of the alpha-derived anhydrite calcium sulfate whiskers and the plastic.

26. The method or composite product according to any one of paragraphs 1 to 4 or 6 to 21, wherein the composite product comprises about 10 wt % to about 20 wt % of the alpha-derived anhydrite calcium sulfate whiskers, based on the combined weight of the alpha-derived anhydrite calcium sulfate whiskers and the plastic.

27. The method or composite product according to any one of paragraphs 1 to 4 or 6 to 21, wherein the composite product comprises about 15 wt % to about 30 wt % of the alpha-derived anhydrite calcium sulfate whiskers, based on the combined weight of the alpha-derived anhydrite calcium sulfate whiskers and the plastic.

28. The method or composite product according to any one of paragraphs 1 to 4 or 6 to 27, wherein the composite product has an elastic modulus of at least 1,000 MPa, as measured according to the Flexural Chord method.

29. The method or composite product according to any one of paragraphs 1 to 4 or 6 to 28, wherein the composite product has an elastic modulus of at least 1,000 MPa, as measured according to the Flexural Tangent method.

30. The method or composite product according to any one of paragraphs 1 to 4 or 6 to 29, wherein the composite product has an elastic modulus of at least 1,000 MPa, as measured according to the Flexural Secant method.

31. The method or composite product according to any one of paragraphs 1 to 4 or 6 to 30, wherein the composite has an elastic modulus of at least 1,000 MPa to about 1,350 MPa, as measured according to the Flexural Chord method.

32. The method or composite product according to any one of paragraphs 1 to 4 or 6 to 31, wherein the composite has an elastic modulus of at least 1,000 MPa to about 1,450 MPa, as measured according to the Flexural Tangent method.

33. The method or composite product according to any one of paragraphs 1 to 4 or 6 to 32, wherein the composite has an elastic modulus of at least 1,000 MPa to about 1,150 MPa, as measured according to the Flexural Secant method.

34. The method or composite product according to any one of paragraphs 1 to 33, wherein the alpha-derived anhydrite calcium sulfate whiskers have a mean aspect ratio of at least 30.

35. The method or composite product according to any one of paragraphs 1 to 34, wherein the alpha-derived anhydrite calcium sulfate whiskers have a Mohs hardness of about 3 to about 3.5.

36. The method according to any one of paragraphs 1, 2, 4, or 6 to 35, wherein the alpha-derived anhydrite calcium sulfate whiskers are combined with the plastic when the plastic is in a molten form.

37. The method according to any one of paragraphs 1, 2, 4, or 6 to 35, wherein the alpha-derived anhydrite calcium sulfate whiskers are combined with the plastic when the plastic is in a solid form.

38. The method according to any one of paragraphs 1, 2, 4, or 6 to 35, wherein the alpha-derived anhydrite calcium sulfate whiskers are combined with the plastic when a first portion of the plastic is in a solid form and a second portion of the plastic is in a molten form.

39. The method or composite product according to any one of paragraphs 1 to 38, wherein the alpha-derived anhydrite calcium sulfate whiskers are at least partially coated with one or more silanes, one or more waxes, one or more stearates, steric acid, or any mixture thereof.

40. The method or composite product according to any one of paragraphs 1 to 39, wherein the alpha-derived anhydrite calcium sulfate whiskers are at least partially coated with calcium stearate.

41. The method or composite product according to any one of paragraphs 1 to 38, wherein the alpha-derived anhydrite calcium sulfate whiskers are at least partially coated with one or more treatment materials, and wherein the one or more treatment materials are present in an amount of about 0.1 wt % to about 5 wt %, based on the weight of the alpha-derived anhydrite calcium sulfate whiskers.

42. The method or composite product according to paragraph 41, wherein the one or more treatment materials comprise one or more silanes, one or more waxes, one or more stearates, steric acid, or any mixture thereof.

43. The method or composite product according to paragraph 41, wherein the one or more treatment materials comprise calcium stearate.

44. The method or composite product according to any one of paragraphs 1 to 4 or 6 to 43, wherein the composite product comprises an automotive component selected from the group consisting of: a bumper, an exterior body panel, an interior body panel, an exterior trim piece, an interior trim piece, a seat component, an under-hood component, an electrical housing, a cable bearing, or a structural component.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A method for making a composite product comprising combining alpha-derived anhydrite calcium sulfate whiskers and a plastic to produce a composite product.

2. The method of claim 1, wherein the plastic comprises a homopolymer, a copolymer, or a mixture thereof.

3. The method of claim 1, wherein the plastic comprises a polyethylene homopolymer, a polypropylene homopolymer, a polyethylene copolymer, a polypropylene copolymer, or any mixture thereof.

4. The method of claim 1, wherein the plastic comprises a thermoplastic copolymer, and wherein the thermoplastic copolymer comprises a blend of a polypropylene homopolymer and a copolymer comprising propylene and one or more comonomers selected from the group consisting of: ethylene and C₄ to C₂₀ olefins.

5. The method of claim 4, wherein the thermoplastic copolymer comprises about 1 wt % to about 9.9 wt % of the comonomer.

6. The method of claim 4, wherein the thermoplastic copolymer comprises about 10 wt % to about 20 wt % of the comonomer.

7. The method of claim 4, wherein the thermoplastic copolymer comprises greater than 20 wt % to about 40 wt % of the comonomer.

8. The method of claim 1, wherein the plastic comprises polyethylene, polypropylene, polybutylene, polyester, polyethylene terephthalate, polycaprolactam, poly(hexamethylene adipamide), polyurethane, epoxy, nitrile rubber, butyl rubber, silicone rubber, polytetrafluoroethylene, phenolics, or any mixture thereof.

9. The method of claim 1, wherein the plastic comprises asphalt, oxidized asphalt, cut-back asphalt, wax, clay, or any mixture thereof.

10. The method of claim 1, wherein the alpha-derived anhydrite calcium sulfate whiskers have a mean aspect ratio of about 30 to about 140.

11. The method of claim 1, wherein the alpha-derived anhydrite calcium sulfate whiskers have a mean diameter of about 0.3 μm to about 1.5 μm.

12. The method of claim 1, wherein the anhydrite calcium sulfate whiskers have a mean length of about 20 μm to about 100 μm.

13. The method of claim 1, wherein the anhydrite calcium sulfate whiskers are combined with the plastic when the plastic is in a molten state.

14. The method of claim 1, wherein the composite product comprises about 1 wt % to about 50 wt % of the alpha-derived anhydrite calcium sulfate whiskers, based on the combined weight of the alpha-derived anhydrite calcium sulfate whiskers and the plastic.

15. A method for making a composite product, comprising:
blending a plurality of alpha-derived anhydrite calcium sulfate whiskers and a plastic to produce a composite product, wherein the composite product comprises about 1 wt % to about 50 wt % of the alpha-derived anhydrite calcium sulfate whiskers, based on the combined weight of the alpha-derived calcium sulfate whiskers and the plastic.

16. The method of claim 15, wherein the plastic is in a molten state when blended with the plurality of alpha-derived anhydrite calcium sulfate whiskers.

17. The method of claim 15, further comprising contacting the alpha-derived anhydrite calcium sulfate whiskers with a treatment material to produce treated alpha-derived anhydrite calcium sulfate whiskers, wherein the treatment material comprises one or more silicon containing compounds, one or more waxes, one or more stearates, steric acid, or any mixture thereof, and wherein the treated alpha-derived anhydrite calcium sulfate whiskers are blended with the plastic to product the composite product.

18. The method of claim 15, wherein the plastic comprises polyethylene, polypropylene, polybutylene, polyester, polyethylene terephthalate (PET), polycaprolactam, poly(hexamethylene adipamide), polyurethane, epoxy, nitrile rubber, butyl rubber, silicone rubber, polytetrafluoroethylene, phenolics, asphalt, oxidized asphalt, cut-back asphalt, wax, clay, or any mixture thereof.

19. A composite product comprising alpha-derived anhydrite calcium sulfate whiskers and a plastic.

20. The composite of claim 19, wherein plastic comprises polyethylene, polypropylene, polybutylene, polyester, polyethylene terephthalate, polycaprolactam, poly(hexamethylene adipamide), polyurethane, epoxy, nitrile rubber, butyl rubber, silicone rubber, polytetrafluoroethylene, phenolics, asphalt, oxidized asphalt, cut-back asphalt, wax, clay, or any mixture thereof.
